(19) United States
(12) Patent Application Publication
(10) Pub. No.: US 2021/0298516 A1
(43) Pub. Date: Sep. 30, 2021

(54) Easy Clean Beverage/Coffee Press

(71) Applicant: Arash Radparvar, Philadelphia, PA (US)

(72) Inventor: Arash Radparvar, Philadelphia, PA (US)

(21) Appl. No.: 17/209,441

(22) Filed: Mar. 23, 2021

Related U.S. Application Data
(60) Provisional application No. 63/125,157, filed on Dec. 14, 2020.
(60) Provisional application No. 62/994,060, filed on Mar. 24, 2020.

(51) Int. Cl. A47J 31/20; A47J 31/60; A47J 31/38

(52) U.S. Cl. CPC A47J 31/20; A47J 31/38; A47J 31/60

(57) ABSTRACT

This inventive system comprises at least a container (carafe), a bottom piece (Mop), and a top piece (plunger). In one embodiment, the top piece has a single hollowed handle into which the handle of the bottom piece inserts. In another embodiment, the top piece has several handles and/or legs that attach to the periphery of the base of the top piece. In this iteration, the handle of the bottom piece (Mop) inserts through a hole in the center of the base of the top piece (plunger).

### CROSS-REFERENCE TO RELATED APPLICATIONS

The present application claims benefit of U.S. Provisional Patent Application Ser. No. 62/994,060 of Radparvar, filed 24 Mar. 2020 and U.S. Provisional Patent Application Ser. No. 63/125,157, Radparvar, filed 14 Dec. 2020, the disclosures of which are hereby incorporated by reference as set forth.

### BACKGROUND OF THE INVENTION

Many different methods for brewing coffee or other beverages exist. One popular technique is the French Press method or system. Many believe French Press coffee is one of the smoothest brews. In addition, many people enjoy the process of grinding the whole beans to get a fresh grind and adding hot water to the French press carafe.

However, cleaning the French press carafe after the brewed coffee is poured into a cup is difficult. The coffee grounds stick to the bottom of the carafe and it is hard to get them out. One usually has to shake the carafe vigorously over a trash can to get the grounds out, which ends up splashing coffee grounds on and about the garbage can and sometimes on the floor. Even then much of the coffee grounds stay stuck to the bottom of the carafe.

Accordingly, an improved French press coffee brewing system in which added feature(s) allow(s) easy removal of the coffee grounds, without compromising the quality of the brew, is needed.

### BRIEF SUMMARY OF THE INVENTION

This inventive system comprises at least a container (carafe), a bottom piece (Mop), and a top piece (plunger).

In one embodiment, the top piece has a single hollowed handle into which the handle of the bottom piece inserts.

In another embodiment, the top piece has several handles and/or legs that attach to the periphery of the base of the top piece. In this iteration, the handle of the bottom piece (Mop) inserts through a hole in the center of the base of the top piece (plunger).

### BRIEF DESCRIPTION OF THE SEVERAL VIEWS OF THE DRAWINGS

FIG. 1 illustrates an embodiment of the inventive system.

FIG. 2A illustrates a bottom piece of one embodiment of the inventive system.

FIG. 2B illustrates a bottom piece of another embodiment of the inventive system.

FIG. 2C illustrates a view looking downward to a portion of one embodiment of the inventive system.

FIG. 3A illustrates another portion of one embodiment of the inventive system.

FIG. 3B illustrates a view looking downward to another portion of one embodiment of the inventive system.

FIG. 3C illustrates portions of one embodiment of the inventive system.

FIG. 4 illustrates yet another embodiment of the inventive system.

### DETAILED DESCRIPTION OF THE INVENTION

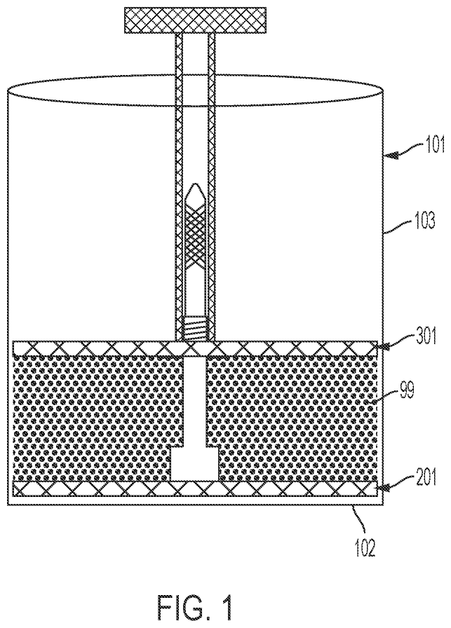

FIG. 1 illustrates an embodiment of the inventive coffee press system. As shown in FIG. 1, the device can generally comprise a jar or a container (carafe) 101, a bottom piece (also referred to as “Mop”) which has a base and a handle 201, and a top piece (plunger) 301. The carafe 101 is generally, but not necessarily, a cylindrically shaped jar or container but other shapes, such as square, rectangle, triangular can also be used. The carafe may comprise a container-base 102 and sides 103. The container 101 may hold the bottom piece (Mop) 201, the ground coffee 99, and the top piece (plunger) 301.

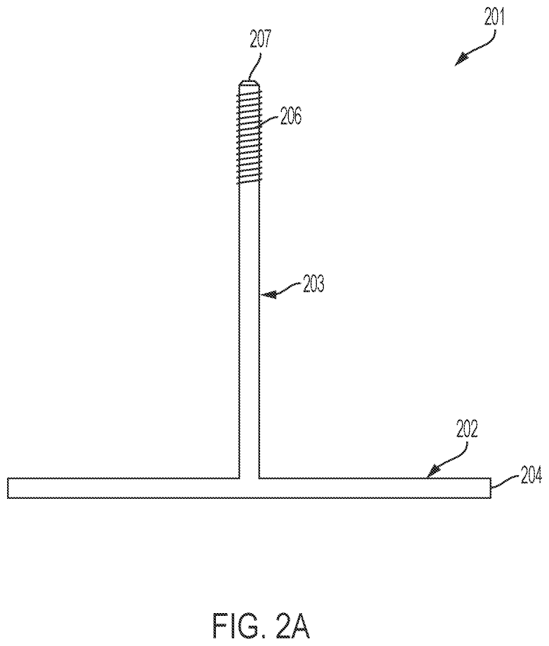

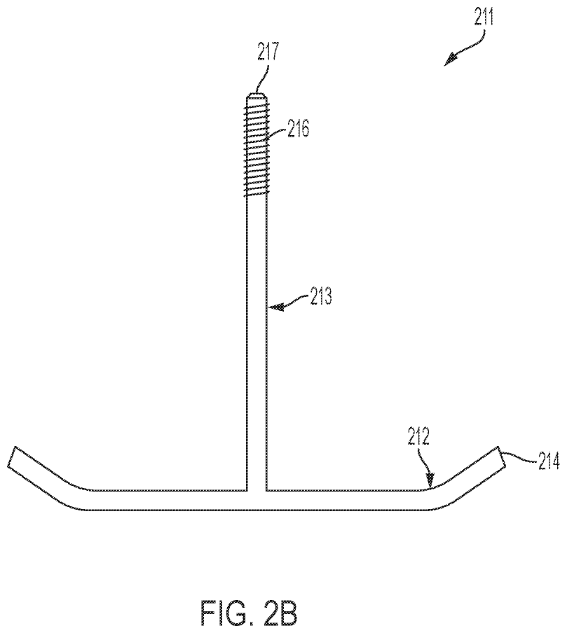

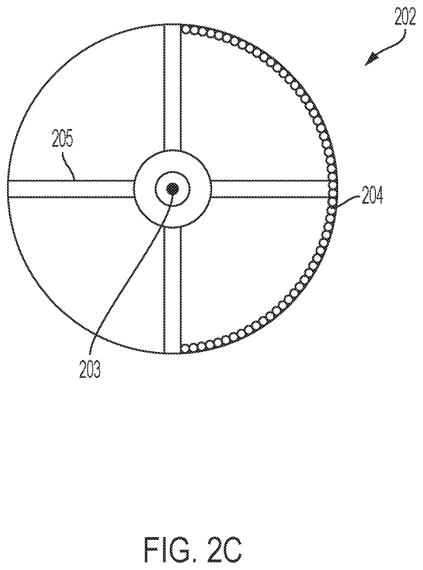

FIG. 2A shows the bottom piece or the Mop 201 in one embodiment. As shown, the bottom piece 201 may comprise a base 202 corresponding to the shape of the container 101 and a vertical handle 203. As shown in FIG. 2A, the base 202, which corresponds to the shape of the container 101, may be round but other shapes may be used as appropriate, in accordance with the shape of the container 101. The base 202 of the bottom piece 201 sits at the bottom of the carafe. The rim or edge 204 of the base of the bottom piece 202 is in close contact with the carafe sidewalls 103. The base of the bottom piece (Mop) 202 may be flat and rimless. Alternatively, the base of the bottom piece may be angled upward in the periphery giving it a cup or basket type property 211, FIG. 2B.

FIG. 2B shows the bottom piece (Mop) 211 in another embodiment. As shown, the bottom piece 211 may have a base 212 and a handle 213. The base may be flat or angles/tilted up in the periphery, forming a cup or basket shape. This cup or basket shape improves and facilitates holding and removing of coffee grinds, as explained below. The base of the bottom filter 212 may be any circumference or diameter to best fit the carafe. The rim 204 of the base 202 of the Mop 201 is in close contact with the inside of the walls 103 of the carafe 101.

FIG. 2C shows a top view, e.g., view looking down, at the bottom piece 201. As shown, the rim 204 of the base of the Mop may be a wire mesh. Preferably, but not necessarily, the rim of the base of the bottom piece may be made from silicon or any other thermoresistant plastic for optimal contact with the sidewall of the carafe. The rim 204 can however be made from any material. The rim of the base of the bottom piece may or may not be from similar material as the rest of the base of the bottom piece.

The base of the bottom piece (Mop) 201 may be one piece and one layer or composed of multiple parts/pieces and layers. It may comprise supports 205 to create a solid support frame.

The base of the bottom piece 202, 212 may be a solid plate or a mesh/filter, or any combination of mesh and solid support frame. Preferably, but not necessarily, the base of the Mop may be made from silicon or any other thermal resistance material. The base of the bottom piece can however be made from any material or any combination of different materials.

In one embodiment the base of the bottom piece (Mop) 202, 212 may preferably be metallic and/or wire material; however other materials may be used. The rim 204 of the base 202 may be a wire mesh or any other type of material such as silicon. This rim may be inherently part of the same material as the base or made with any material other than the rest of the base.

The base 202 may be a single piece or a single layer. In other embodiments, the base 202 may be comprised of multiple layers and/or components.

The handle 203, 213 of the bottom piece (Mop) may comprise a top portion 206, 216 and a tip 207, 217. The handle 203, 213 may be made of any material, including but not limited to metal, glass, or other material. The handle 203, 213 can be of any length, thickness, or height. In one embodiment, the tip 207, 217 may be pointed or somewhat sharp to enable perforation and/or connection with the top piece, as discussed below.

In one embodiment, the length of the handle of the bottom piece 203, 213 may preferably (but not necessarily) be slightly less than the height of the container 101. In this embodiment, the handle 203, 213 will not stick out of or extend beyond the top of the container 101. This shorter length will not interference with pouring of the ground coffee into the container 101. However, Mop handle 203, 213 may be of any length as deemed appropriate.

The top portion 206, 216 of the handle 203, 213 of the bottom piece 201, 211 may be textured for easier grip and pull out. This may be done by any variety of texturing of the handle 206, 216 and/or by adding a grip friendly material such as, but not limited to, silicon or any other material, to the handle 203, 213 for easy grip and extraction of the Mop 201, 211.

The handle 203, 213 of the Mop 201, 211 may connect to the center of the base 202, 212 by any type of linkage or connecting mechanism. Generally the handle 203, 213 is a separate piece from the base and screws directly to the center of the base 202, 212. However, the handle may connect via an added screw, bolt or any other linkage or connecting piece.

Alternatively, the handle may be an inherent part of the base and permanently fused with the support material of the base. This may be achieved by welding or any other type of fusion method.

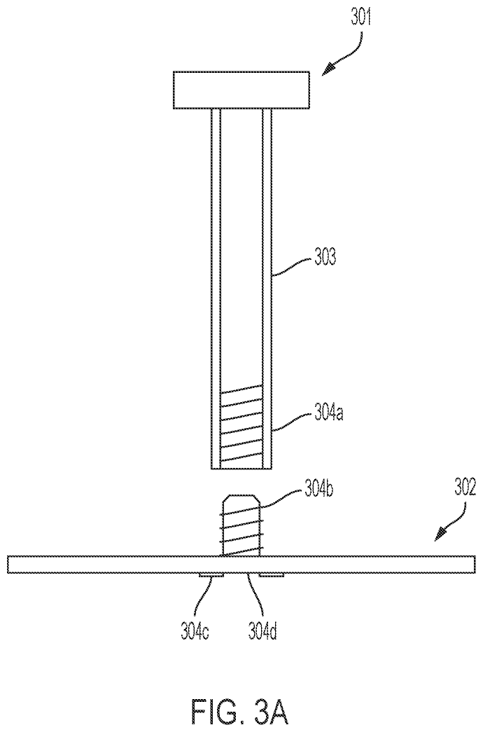

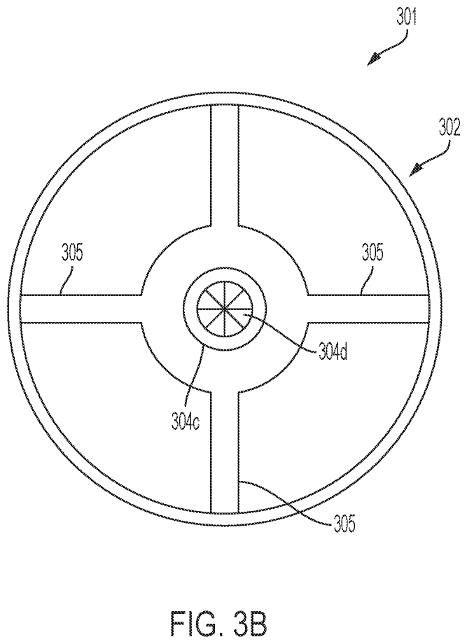

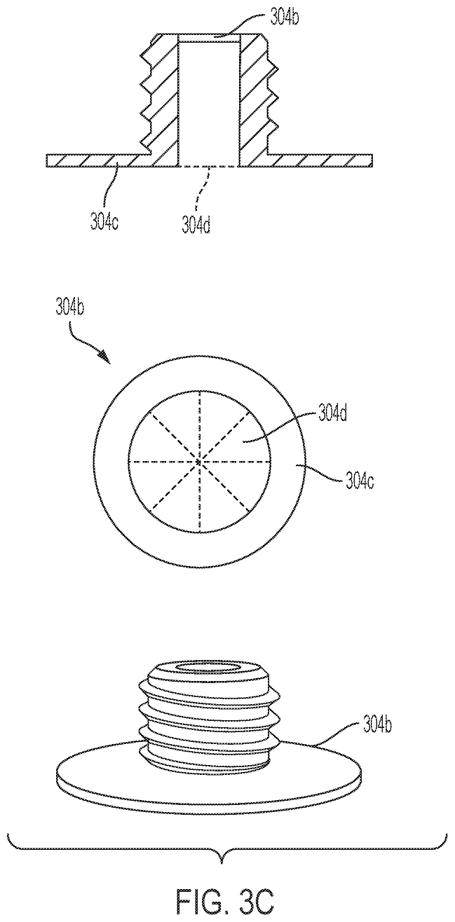

FIG. 3A shows the top piece (plunger) 301, which can comprise two main parts: plunger-base 302 and plunger-handle 303. The plunger-base 302 may correspond in shape to the shape of the carafe 101. For example when the container 101 is cylindrical, the plunger-base 302 is generally round. However, the plunger-base 302 may have any other shape as appropriate.

The plunger-base 302 may be composed of one part or one layer of mesh and a solid support frame of metallic or any other material or multiple parts and layers (for example, as in a traditional French Press).

The plunger-base 302 may be made from any material or combination of materials, and may comprise a meshwork and supporting solid elements and/or plates. The plunger-base 302 may be made of a metallic and/or wire material but may also be made from any other material.

There is a hole in the center of the base of the plunger. This hole allows passage of the handle 203, 213 of the Mop 201, 211 through the base of the top piece (plunger) into the hollowed handle 303 of the plunger 301.

The center or core of the handle 303 of the plunger 301 is hollow. This allows the handle 203, 213 of the bottom piece 201, 211 to enter inside the handle 303 of the plunger 301.

FIG. 3B shows a bottom view, e.g., view looking up, at the base of the plunger 301. As shown, the plunger-base 302 may comprise plunger-supports 305 to create a solid support frame and filters or mesh as in a traditional French press.

The handle 303 of the plunger 301 may be permanently attached to the base 302 of the plunger or connect to the base via a screw or any other types of connecting mechanisms (connectors).

In one embodiment, the handle 303 of the plunger 301 may be an inherent part of the base 302 of the plunger 301.

In another embodiment, the handle 303 of the plunger 301 may directly screw to the base 302 of the plunger 301 or directly connect to it via any other type of connection or linkage.

The plunger-handle 303 may directly or indirectly connect (screw or any other way or other types of linkage) to the plunger-base 302. As shown in FIG. 3A, the plunger-handle 303 comprises receiver mechanism 304a inside the plunger-handle 303 and a connecting mechanism 304b on the plunger-base 302. The connecting mechanism 304b may be a bolt mechanism.

In another embodiment, the handle 303 of the plunger 301 may connect to the base 302 via a screw or a bolt 304b or any connector piece, see FIG. 3C. In this embodiment, a hollowed connector screw or hollowed bolt will allow the passage of the handle 203, 213 of the bottom piece (Mop) 201, 211 into the hollowed handle 303 of the plunger 301. Generally, but not necessarily, the connector piece or bolt 304b connects the base 302 of the plunger 301 to the handle 303 by screwing inside the hollowed handle 303 of the plunger 301.

If the handle of the plunger directly connects to the base of the plunger (for example by screwing directly to the base), the base screw is hollow in the center/core to allow the passage of the handle of the Mop into the handle of the plunger.

The hole in the center of the base 302 of the plunger 301 or the hole in the hollowed connector piece (FIG. 3 C) may be covered with a mesh 304d to prevent the passage of coffee grounds up into the hollowed handle 303 of the plunger 301.

The mesh 304d covering the hole in the center of the base 302 of the plunger 301, or the hollowed center of the connector piece, may be made from any material. This mesh may have perforations that facilitate penetration and passage of the handle 203, 213 of the Mop 201, 211 through the mesh membrane.

As such, the pointed tip 207, 217 of the handle 203, 213 of the Mop 201, 211 penetrates and continues to insert into the plunger-handle 303. This mesh membrane 304d is designed to prevent coffee grounds, tea leaves, etc., from migrating upward along the handle 203, 213 of the Mop 201, 211 into the top or plunger handle 303.

The mesh membrane 304d may be built into the connector/bolt 304b or be a part of the base 302 of the plunger 301.

The mesh membrane 304d covering the central hole, preferably but not necessarily, has perforated/dotted lines which intersect in the center. These lines allow the handle 203, 213 of the Mop 201, 211 to easily penetrate the covering mesh membrane 304d.

FIG. 3C illustrates one embodiment having a bolt 304b shown in detail. The bolt 304b may connect the plunger handle 303 to the plunger base 302. At the top of FIG. 3C, a section side view of bolt 304b is shown. In the middle of FIG. 3C, a view looking down at the bolt 304b illustrates the base 304c of the bolt 304b and a mesh membrane 304d covering the base of the hollow core of the bolt 304b. At the bottom of FIG. 3C, the bolt 304b is shown at an angle.

In one embodiment, the plunger handle 303 of the top piece 301, may screw over the short stem or bolt 304b sticking up from the center of the plunger-base 302. In one embodiment, the connector is a bolt 304b which screws inside the plunger-handle 303 and connects the plunger-base 302 to the plunger-handle 303.

In other embodiments, the connector/bolt may screw outside the plunger-handle or connect the plunger base 302 to the plunger-handle 303 in any other fashion. Alternatively, the plunger-handle 303 can directly connect by any connection method to the plunger base 302 directly and independent of a separate connector/bolt.

In one embodiment, the plunger-handle 303 is part of the plunger-base 302 and inseparable from it. For example the plunger handle 303 may be welded to the base 302 or permanently attach to or fused with the base by any other mechanism.

A hole in the plunger-base 302 at the attachment of the plunger-handle 303 allows passage of the handle 203, 213 of the bottom piece 201, 201 into the hollowed plunger-handle 303 of the top piece 301. This hole may be covered by a filter or mesh (as described above) to prevent the passage of the coffee grounds or tea leaves upwards into the hollowed handle of the top piece or into the brewed beverage (coffee, tea, . . . , etc.).

The inventive system may connect by inserting the handle 203, 213 of the bottom piece 201, 211 inside the hollowed handle 303 of the top piece or plunger 301.

In one embodiment, the handle 203, 213 of the bottom piece 201 may remain free of the plunger handle 303. In another embodiment, the handle 203, 213 of the bottom piece 201 may lock inside the plunger handle 303, 313 using any type of lock (and release) system or linkage.

By locking the handle 203, 213 of the bottom piece 201, 211 inside the plunger handle 303, the bottom piece 201, 211 can be removed out of the carafe 101 by removing the top piece 301.

The handle 203, 213 of the bottom piece 201, 211 may subsequently be released from the plunger handle 303 of the top piece 301 by any type of release (unlocking/unlinking) mechanism.

In one embodiment, a one-way locking system may join the top piece 301 and the bottom piece 201, 211. In this embodiment, the handle 203, 213 of the bottom piece 201, 211 may be inserted inside the hollowed plunger-handle 303 of the top piece 301 enabling the Mop handle 203, 213 and plunger-handle 303 to lock together. In this embodiment, pulling out or removing the plunger 301 will also cause the Mop 201, 211 to come out. After extraction or removal of the top piece 301 and bottom piece 201, 211, the top and bottom or pieces may separate by and type of release mechanism.

However, the handle 203, 213 of the bottom piece 201, 211 may remain free and unlocked inside the hollowed handle 303 of the top piece 301.

In another embodiment the plunger-base and the plunger-handle are integral parts of the plunger. The support element of the plunger-base can protrude upward and has a screw or bolt connection portion that connects the plunger-base to the plunger-handle. The mesh mechanism resides in the plunger-base. The plunger-base further comprises a filter.

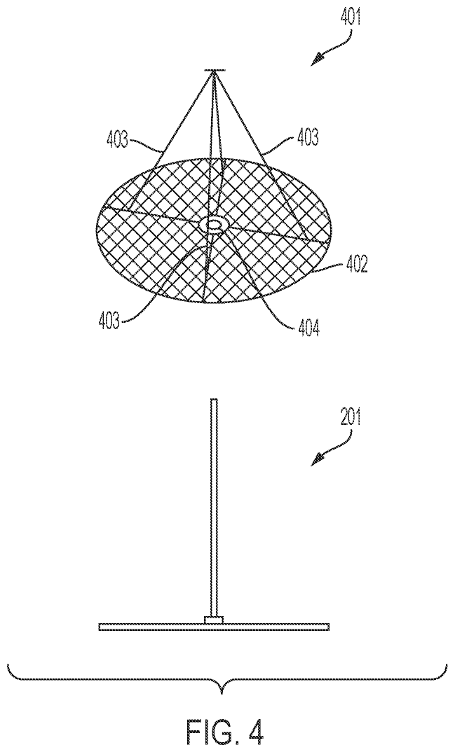

FIG. 4 illustrates yet another embodiment of the inventive system. As shown, the top piece (plunger) 401 may comprise a base 402 and several legs 403. Each leg 403 has two ends, one connects to the base 402 and the other, opposing end, connects together, on top, with all of the other legs 403. The legs 403 may connect anywhere, such as in the center or periphery of the base 402. The legs 403 replace and function as the plunger handle in the traditional French press and may be used to insert and remove the top piece 401 into the container 101.

The legs 403 may be made of any length and/or height and from any material, and the legs 403 may be straight, curved, spiral, or any other shape. The legs 403 may directly or indirectly attach to the base 402 with any type of connection, attachment or linkage. In one embodiment, the legs 403 may be fused with the base 402 and be inseparable from the base as one piece. In one embodiment, the legs 403 may be hollow.

The base further comprises a hole 404 in the center, similar to the traditional plunger base 302, and may or may not be covered with a mesh mechanism. This hole 404 has a similar role and function as the hole in the center of the base of the plunger 302.

Exemplary steps for use of the inventive system may be as follows:

Step 1: insert the bottom piece (Mop) 201, 211 into the carafe 101. While holding on to the handle 203, 213, push the bottom piece 201, 211 down to the bottom of the carafe 101.

Step 2: pour ground coffee (loose tea leaves, etc.), over bottom piece 201, 211 into the carafe 101, and add hot water. Note that the coffee grounds will stay on top of the base of the bottom piece 201, 211.

Step 3: insert the top piece (plunger) 301 into the container 101.

Step 4: after desired brewing time, push the top piece 301 down to press the coffee or other beverage. As the top piece 301 pushes down, the handle 203, 213 of the bottom piece 201, 211 enters the hollowed handle 303 of the top piece 301 through the hole in the base of the top piece (plunger), or the bolt 304b or through the hollow screw part of the base of the top piece 301. The brewed coffee will filter to the top above the top piece 301 and the coffee grounds will remain between the top piece 301 and the bottom piece 201, 211.

Step 5: after extracting the brewed coffee, or other beverage from the container 101, typically by pouring the beverage into another cup or container, remove the top piece 301.

Step 6A: if the handle 203, 213 of the bottom piece 201, 211 is designed to lock into the inside of the plunger-handle 303 of the top piece 301, the bottom piece 201, 211 will be pulled out as the plunger 301 is removed. As the bottom piece 201, 211 is removed from the container 101, the coffee grounds will be pulled out with it and no residual ground will remain stuck to the container 101.

Step 6B: if the handle 203-213 of the Mop 201, 211 is not designed to lock inside of the plunger handle 303, the Mop 201, 211 may be removed by holding on to the easy grip textured top portion 206, 216 of the handle 203, 213. As the bottom piece (Mop) 201, 211 comes out of the carafe 101, it will extract the coffee grounds with it out of the carafe. This makes the process of cleaning the container 101 much easier.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and subcombinations of the various features described hereinabove, as well as variations and modifications thereof which would occur to persons skilled in the art upon reading the foregoing description and which are not disclosed in the prior art.

What is claimed:

1. A system comprising:
a carafe comprising an open end, a bottom and sidewalls;
a bottom piece (Mop) comprising a bottom-base and a bottom-handle, the bottom piece insertable into the carafe; and
a top piece (plunger) comprising a plunger-base and a hollow plunger-handle, the top piece insertable into the carafe after the bottom piece is inserted, wherein the bottom-handle inserts into the plunger-handle. This may or may not enable the bottom piece and the top piece to be simultaneously removed from the carafe.

2. The system of claim 1, wherein the bottom-base is flat.

3. The system of claim 1, wherein the bottom-base has a curved/angled rim.

4. A system comprising:
a carafe comprising an open end, a bottom and sidewalls;
a bottom piece comprising a bottom-base and a bottom-handle, the bottom piece insertable into the carafe; and
a top piece comprising a plunger-base and at least one leg attached to the plunger-base, the top piece insertable into the carafe after the bottom piece is inserted, wherein the bottom-handle enters the top piece through a hole in the center of the plunger-base, said attaching enabling the bottom piece and the top piece to be simultaneously removed from the carafe.

5. The system of claim 4, wherein the bottom-base is flat.

6. The system of claim 4, wherein the bottom-base has a curved rim.
